(19) United States
(12) Patent Application Publication
(10) Pub. No.: US 2005/0235772 A1
(43) Pub. Date: Oct. 27, 2005

(54) Energy-absorbing steering wheel

(75) Inventors: Richard Becker, Grossostheim (DE); Norbert Muller, Aschaffenburg (DE)

Correspondence Address: FITCH EVEN TABIN AND FLANNERY, 120 SOUTH LA SALLE STREET, SUITE 1600, CHICAGO, IL, 60603-3406, US

(73) Assignee: Takata-Petri AG

(21) Appl. No.: 11/111,328

(22) Filed: Apr. 21, 2005

(30) Foreign Application Priority Data
Apr. 21, 2004 (DE) 20 2004 006 494.4

(51) Int. Cl. B62D 1/04

(52) U.S. Cl. 74/552

(57) ABSTRACT

An energy-absorbing steering wheel, in particular a large-volume steering wheel for HGVs is disclosed, with a steering-wheel skeleton with hub, spokes and steering-wheel rim which are provided with a casing, the skeleton portions of the spokes extending from the steering-wheel rim as far as the hub, and the region above the hub being of energy-absorbing design. There is provision for the casing to have, at least in the region above the hub, at least one cavity for assisting the energy absorption.

### FIELD OF THE INVENTION

The invention relates to an energy-absorbing steering wheel.

### BACKGROUND OF THE INVENTION

Large-volume steering wheels, such that are used, for example, for heavy goods vehicles, do not, as a rule, have any airbag modules. Thus, DE 30 48 771 C2 discloses an energy-absorbing steering wheel, in which the steering-wheel rim, the spokes and a thin-walled impact bowl extending between the spokes and the steering-wheel hub are produced in one piece from nylon. In this case, the spokes extend out from the steering-wheel rim to the upper edge of the impact bowl which is arranged centrally on the steering wheel and is covered on top with an impact plate. In the event of the driver's impact against the steering wheel, first the impact plate and subsequently the impact bowl are deformed.

Furthermore, steering wheels are known from practice, in which the spokes and consequently also the spoke trim extend from the steering-wheel rim towards the steering-wheel hub. In these steering wheels, inserts consisting of energy-absorbing plastics are arranged as a filling piece and for energy absorption. These inserts in this case consist of a different material from that of the steering-wheel casing. The production of a steering wheel, using different plastics, is complicated and correspondingly costly.

### SUMMARY OF THE INVENTION

The object on which the invention is based is, therefore, to construct an energy-absorbing steering wheel of the last-mentioned type, in such a way that it can be produced at a lower outlay and consequently at lower costs.

This is achieved, according to the invention, by virtue of the features discussed hereinafter.

In an energy-absorbing steering wheel, in particular a large-volume steering wheel for HGVs, with a steering-wheel skeleton with hub, spokes and steering-wheel rim which are provided with a casing, the skeleton portions of the spokes extending from the steering-wheel rim as far as the hub, and the region above the hub being of energy-absorbing design, there is provision, according to the invention, for the casing to have, at least in the region above the hub, at least one cavity for assisting the energy absorption. In this steering wheel according to the invention, plastic inserts consisting of another type of plastic for energy absorption are deliberately dispensed with. Energy absorption is achieved by means of the cavity in conjunction with the steering-wheel casing.

The amount of energy absorption can be influenced by the different configuration of the cavity. A cavity preferably extends from the hub into the upper region, facing the occupant, of the casing.

It is expedient that the casing has, above the cavity, a thickness which allows deformation under the impact of the occupant, without at the same time breaking. A casing consisting of PUR foam, in one embodiment, has a thickness of 10 to 20 mm above the cavity.

It is expedient, furthermore, that the cavity extends laterally into the region of the spokes. In the region of a badge applied to the steering-wheel casing, the cavity may have an orifice which is closed by means of the badge.

In the arrangement according to the invention, energy absorption can be adapted to different requirements in a simple way by means of further variations. Energy absorption can be varied by the variation of the wall thickness.

### BRIEF DESCRIPTION OF THE DRAWINGS

The invention will be explained in an exemplary embodiment, with reference to drawings in which:

FIG. 1 shows a top view of a steering wheel, only the left-hand side of the steering wheel being illustrated;

FIG. 2 shows an embodiment according to the section A-A through the steering wheel of FIG. 1.

### DETAILED DESCRIPTION OF THE PREFERRED EMBODIMENTS

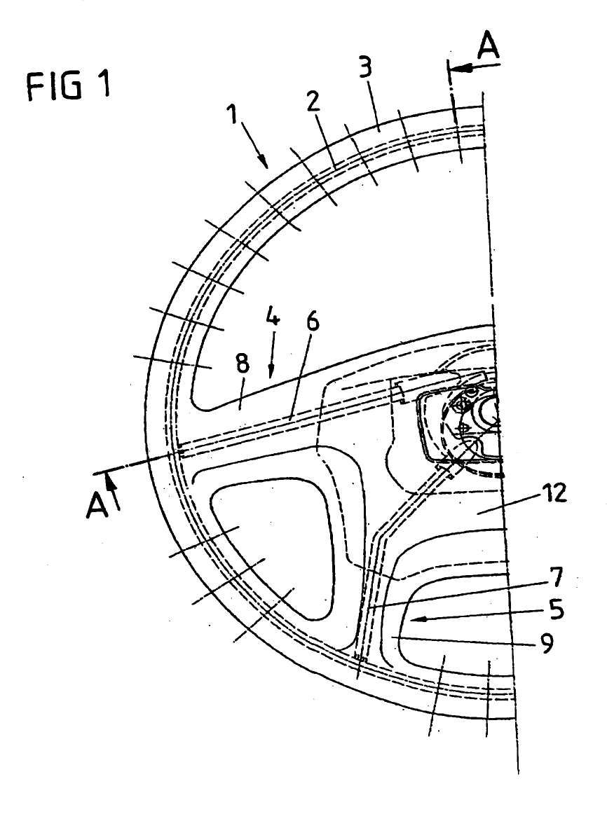

FIG. 1 shows a top view of a steering wheel, only half of the steering wheel being illustrated. The right-hand half, not illustrated, corresponds mirror-symmetrically to the left-hand half illustrated. The steering wheel has a steering wheel rim 1 which consists of a steering-wheel rim skeleton 2, illustrated by broken lines, and of a steering-wheel rim casing 3. Furthermore, the steering wheel has four spokes, of which only two-spokes 4, 5—are illustrated. The spokes consist of a skeleton 6 or 7 and of a spoke casing 8 or 9.

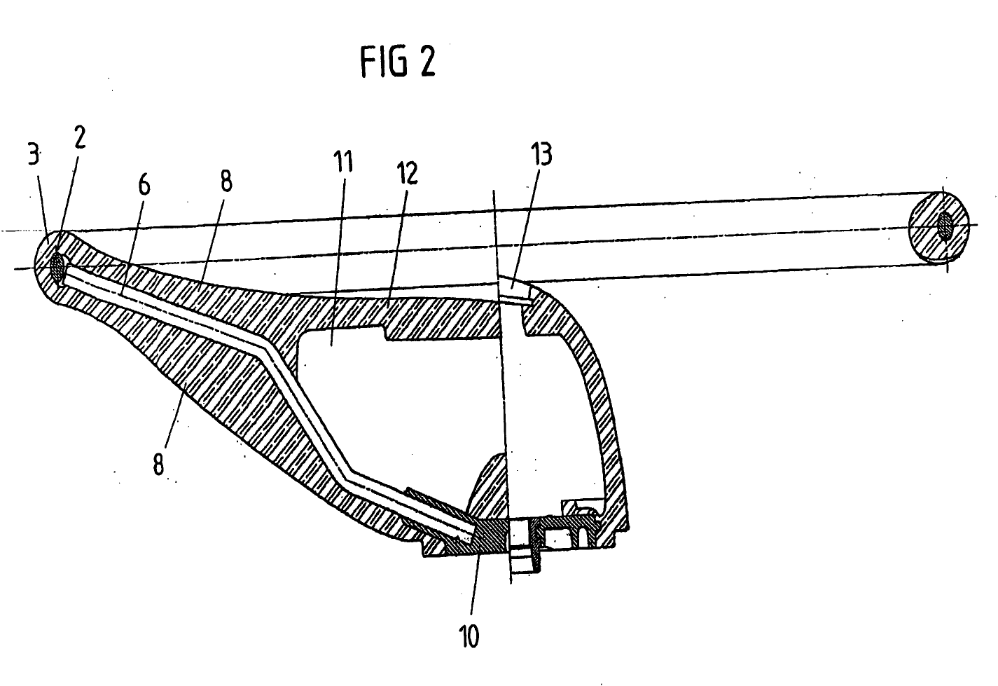

It can be seen in the section of FIG. 2 that the spoke skeleton 6 extends from the steering-wheel rim skeleton 2 as far as a steering-wheel hub 10. In this case, the spoke skeleton 6, starting from the steering-wheel rim, is initially surrounded completely by the spoke casing 8. By contrast, in the middle region of the steering wheel, there is a cavity 11 which extends from the steering-wheel hub 10 as far as the upper casing in the form of the cover 12 in the middle portion of the steering wheel.

It is evident from the section portion lying on the right of the centre line and extending as far as the middle of the steering wheel that, in this embodiment, the middle of the cavity has an orifice 13 which is subsequently closed by means of a badge, not illustrated.

In the event of the impact of an occupant against this steering wheel, the upper cover 12 is deformed in the middle region of the steering wheel. The air in the cavity 11 is thereby compressed and thus contributes to energy absorption.

1. An energy-absorbing, large-volume steering wheel for HGVs, comprising: a steering-wheel skeleton with hub, spokes and steering-wheel rim which are provided with a casing, the skeleton portions of the spokes extending from the steering-wheel rim as far as the hub, and the region above the hub being of energy-absorbing design, characterized in that the casing has, at least in the region above the hub, at least one cavity for assisting the energy absorption.

2. The steering wheel according to claim 1, wherein the cavity extends from the hub into the upper region, facing the occupant, of the casing.

3. The steering wheel according to claim 1, wherein the casing has, above the cavity, a thickness which allows deformation under the impact of the occupant, without at the same time breaking.

4. The steering wheel according to claim 1, wherein the casing is of PUR foam and has a thickness of 10 to 20 mm above the cavity.

5. The steering wheel according to claim 1 wherein the cavity extends laterally into the region of the spokes.

6. The steering wheel according to claim 1, wherein the cavity has a badge applied to the steering-wheel casing, and an orifice which is closed by means of the badge.
